(19) United States
(12) Patent Application Publication
(10) Pub. No.: US 2002/0169880 A1
(43) Pub. Date: Nov. 14, 2002

(54) Method and device for robust real-time estimation of the bottleneck bandwidth in the internet

(75) Inventors: Dmitri Loguinov, Wappingers Falls, NY (US); Hayder Radha, Mahwah, NJ (US)

Correspondence Address: Michael E. Marion, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/837,936

(22) Filed: Apr. 19, 2001

(51) Int. Cl. G06F 15/16

(52) U.S. Cl. 709/228

(57) ABSTRACT

A method and device for estimating the bottleneck bandwidth over a communication network is provided. The method includes the steps of: transmission by the sever through a bottleneck link a plurality of bursts comprised of packets to the client; calculating a set of bandwidth samples for each burst received by the client end; determining a new bottleneck bandwidth from the calculated bandwidth samples for the following transmission of data packets between the server and the client. The device capable of estimating a bottleneck bandwidth includes: a means for transmitting a plurality of bursts comprised of packets; a means for receiving each burst packets via a bottleneck link; a means for generating a set of bandwidth samples based on a difference between an inter-packet spacing between the first and the last packet within each burst; and, a means for determining the current bottleneck bandwidth from the generated bandwidth samples.

### BACKGROUND OF THE INVENTION

1. Field of invention

The present invention relates to the field of the Internet. More particularly, the present invention relates to a method and system for estimating in real time the bottleneck bandwidth of the Internet system.

2. Description of the Invention

The Internet has grown into a vastly diverse connection of many different networks and consists of links of greatly varying bandwidths. As a result, the end-to-end network parameters of the Internet have become more complicated to determine. In addition, most data applications cannot predict their own traffic parameters. Accordingly, the Internet system usually requires a service that dynamically estimates and adapts to the bottleneck bandwidth of an end-to-end Internet path. The bottleneck bandwidth represents the speed of the slowest link of an end-to-end path.

FIG. 1 depicts the conventional estimation mechanism known as Receiver-Based Packet Pair (RBPP). For the purpose of simplicity and clarity, the vertical dimension of the packets represents the link speed, and the horizontal dimension represents the transmission time. In the conventional RBPP method, the sender transmits to the receiver two back-to-back packets (which are called the packet pair), of sizes s₁ and s₂, respectively. As these packets traverse an end-to-end path, they are spread out by the bottleneck link. The spacing between the arrived packets is typically increased because the bottleneck link is slower than the previous links. As a consequence, it takes longer to transmit each packet over the slow bottleneck link. In the remaining path, the new spacing ΔT between the packets is preserved unless much a slower bottleneck link is encountered.

As shown in FIG. 1, upon receiving the spaced packets, the receiver computes the value of the bottleneck bandwidth B_{B}, which is calculated by s₂/ΔT according to the conventional method. Thereafter, the receiver generates a special packet or acknowledgment packet (ACK) with the computed estimate value, B_{B}, and transmits it back to the sender. The sender can then adjust the sending rate based on the estimation of the bottleneck bandwidth B_{B}.

Another prior art method currently deployed follows a Packet Bunch Modes (PBM) technique, which is basically steamed from the above RBPP method. The PBM is aimed at measuring the bottleneck bandwidth during an off-line mode. In addition, the PBM applies a series of filtering and estimation techniques to all samples collected during a given session, thereby requiring an entire set of bandwidth samples to be ready at the time of estimation.

Both of the above prior art methods of estimating the bandwidth have many drawbacks. First, both techniques are highly sensitive to packet compression events—a phenomenon which occur when packets arrive closer to each other than they were originally sent out. Thus, both methods produce an inaccurate estimation of bottleneck bandwidth if employed in the existing Internet in real-time. In addition, as the second method is proposed for off-line operation and requires an entire set of bandwidth samples to be ready at the time of estimation, real-time application of the method is not feasible. Moreover, both methods do not address the delay variation incurred by the OS kernel of the client machine during the scheduling and switching operations. Hence, the detected inter-packet spacing AT may be significantly skewed by the OS operation before the packets are passed to the destination node, thus resulting in an inaccurate estimation of the bottleneck bandwidth BB. Furthermore, both methods require the transmission time stamps to be placed in each packet, thereby increasing the overhead. In addition, RBPP sends special probe packets to measure the bandwidth and incurs extra bandwidth overhead.

Therefore, there is a need for an improved method and system to accurately measure the bottleneck bandwidth in a real-time application.

### SUMMARY OF THE INVENTION

In the preferred embodiment, the present invention relates to estimating the real-time bottleneck bandwidth of an end-to-end Internet path between a server and client. Accordingly, a method capable of estimating the bottleneck bandwidth is provided and includes the steps of: transmitting by the sever through a bottleneck link a plurality of bursts comprised of packets to the client; calculating a set of bandwidth samples for each burst received by the client end; and, determining a new bottleneck bandwidth from the calculated bandwidth samples for the following transmission of data packets between the server and the client.

The present invention relates to a device for estimating the bottleneck bandwidth and includes: a means for transmitting a plurality of packet bursts; a means for receiving each burst packet via a bottleneck link; a means for generating a set of bandwidth samples based on the difference between an inter-packet spacing between the first and the last packet of each burst; and, a means for determining a new bottleneck bandwidth based on the generated bandwidth samples.

### BRIEF DESCRIPTION OF THE DRAWINGS

FIG. 1 illustrates a conventional bandwidth estimation mechanism;

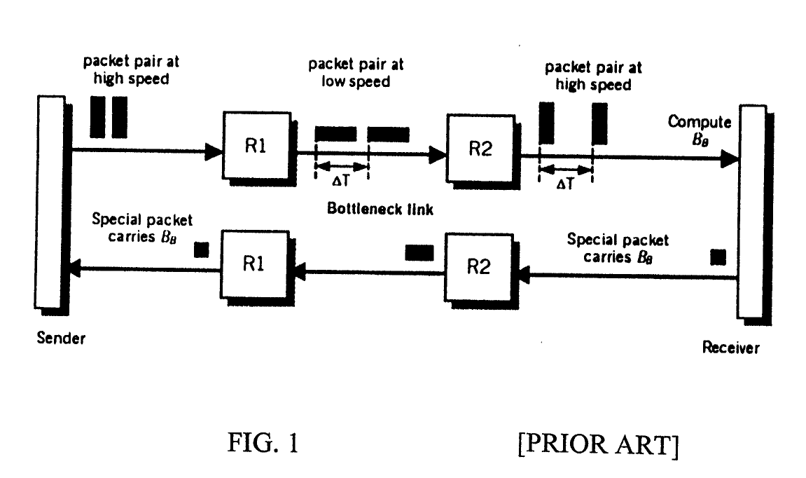

FIG. 2 is a schematic view of an exemplary architecture of the bandwidth estimating system according to the present invention;

FIG. 3 illustrates the format of a user datagram protocol (UDP) packet at the server end in accordance with the present invention;

FIG. 4(a) is a flow chart illustrating the operation of the bottleneck bandwidth estimator according to the present invention;

FIG. 4(b) is a flow chart illustrating a greater detail of estimating the bottleneck bandwidth estimator according to the present invention;

FIG. 5 illustrates a particular mechanism of estimating the bandwidth of the packets of the burst according to the present invention; and,

FIG. 6 illustrates a particular mechanism of handling the packet compression event according to the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments which depart from these specific details. Moreover, for the purpose of clarity, detailed descriptions of well-known devices, circuits, and methods are omitted so as not to obscure the description of the present invention with unnecessary detail.

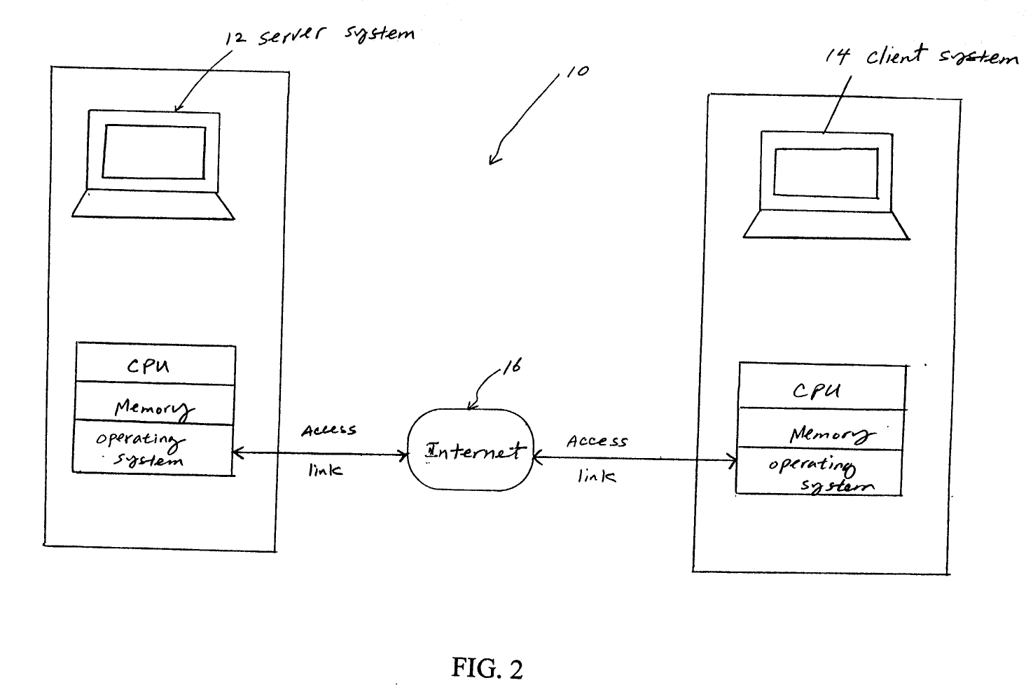

Referring to FIG. 2, the server-client architecture 10 for streaming multimedia data over the Internet according to an exemplary embodiment of the present invention includes a first system 12, such as a server device, a second system 14, such as a client device. Both server and client are in communication with each other via the access link of the Internet network 16. The embodiment of the present invention is aimed at estimating a bottleneck bandwidth, which represents the speed of the slowest link of an end-to-end path, in a rapid and reliable way for the following transmission of data packets.

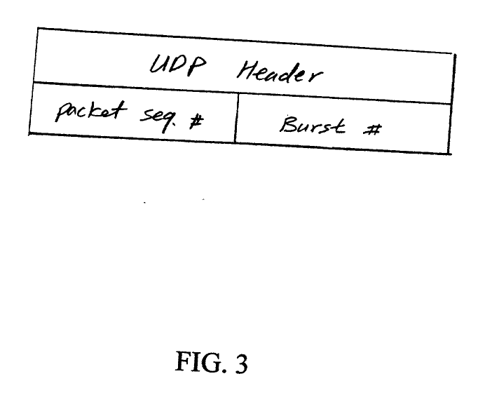

According to the exemplary embodiment of the present invention, the system 10 provides the server system 12 to use video traffic (i.e., burst packets) to estimate the bottleneck bandwidth rather than sending special packet pairs to measure the bottleneck bandwidth as in the prior art. The format of a UDP packet of each burst packet according to the present invention is shown in FIG. 3. Each packet in real-time application carries a burst identifier, which allows the receiver to distinguish packets from different bursts. For simplicity, the inventive bandwidth measurement will be referred to hereinafter as Extended Receiver-Based Packet Pair (ERBPP).

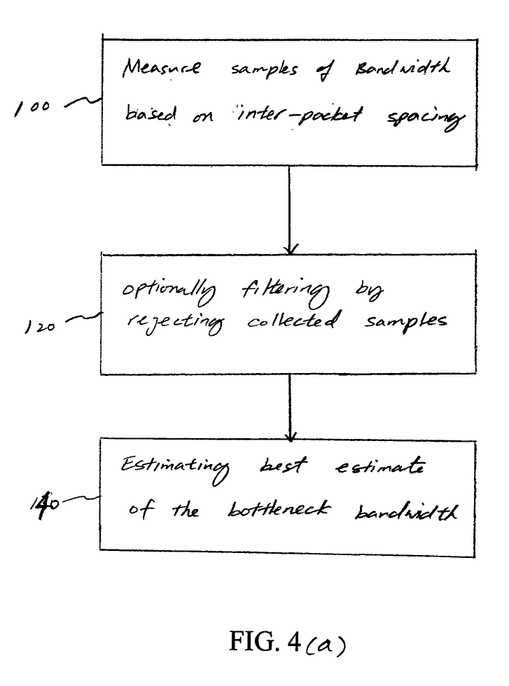

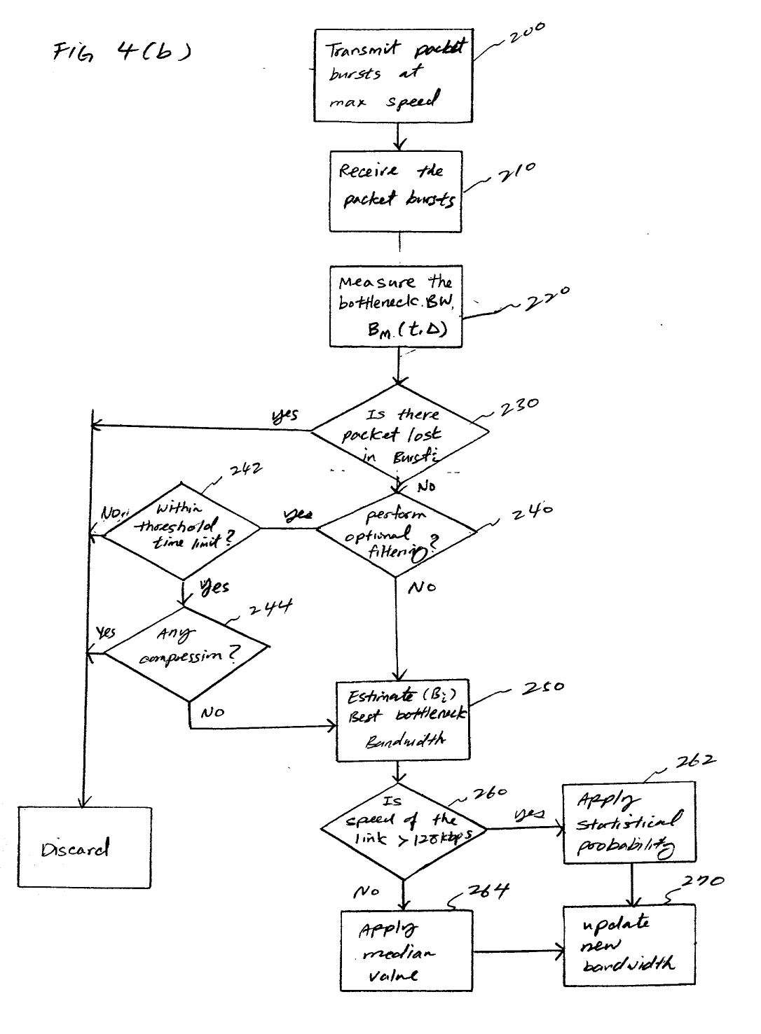

Now, a detailed description of performing real-time bandwidth estimation according to an exemplary embodiment of the present invention will be explained below in conjunction with FIG. 4(a) and FIG. 4(b).

Referring to FIG. 4(a), the inventive bandwidth estimation process consists of three steps—measurement step 100, filtering step 120, and estimation step 140. The filtering step 120 is an optional operation that is performed to further increase the accuracy of the bandwidth samples generated in the measurement step 100. Initially, the server system 12 transmits a plurality of bursts comprised of packets to the client system 14 via a bottleneck link path. In step 100, the bandwidth for each burst received at the client system 14 within a predetermined period is measured and collected in a set of samples B_{M}(t, Δ). Then, in step 120, certain collected samples are removed from the sample set due to the suspected compression or expansion caused by OS-related scheduling delays in delivering packets to the application layer. Again, the filtering step 120 is not required and only executed if a more accurate estimation can be obtained under the prevailing condition of the network. In step 140, a single estimate b_{EST}(t, Δ) that is the most recent and accurate estimation of the bottleneck bandwidth is determined according to the predetermined criteria. The principle of these three major operations will be described in greater detail below.

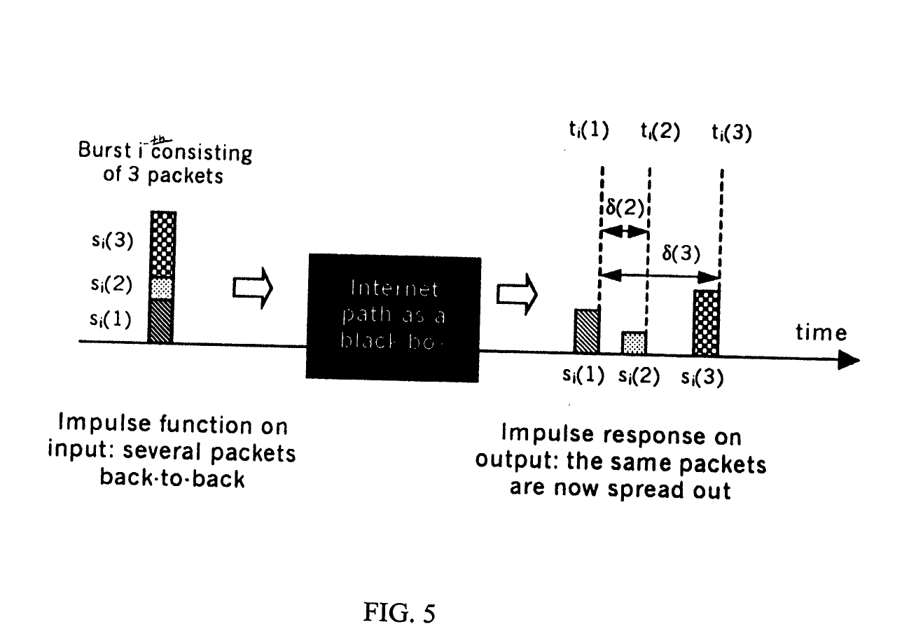

Referring to FIG. 4(b), according to an exemplary embodiment of the present invention, the server system 12 transmits data packets containing actual real-time data in bursts in step 200. Here, the packets that the server system 12 has to deliver to the client system 14 are transmitted at a maximum transmission speed of the adjacent link to guarantee the condition that the packets traveling along the end-to-end Internet path are queued and delayed at the bottleneck link. That is, the packets of each burst have to leave the server system 12 at a rate that is definitely higher than the bottleneck link's speed, so that the packets in each burst can be expanded before they arrive to the client system 14, as shown in FIG. 5. It is be noted that although the server system 12 uses packets of a different size in FIG. 5, the server system 12 may send packets of equal size in the embodiment of the present invention.

Then, in step 210, these packets pass through the Internet network and arrive at the client system 14. Upon receiving a plurality of packet bursts, the client system 14 computes the corresponding bottleneck bandwidth Bi for each packet burst i received therein, in step 220. At this time, if there is a packet loss in any one of the bursts received at the client system 14, the bandwidth sample based on the burst with a missing packet is not included in the set of bandwidth samples, B_{M}(t, Δ) in step 230. To achieve this, the client system 14 analyzes the header information of the respective burst, as shown in FIG. 3, to identify any missing packets within a given burst. In addition, bursts of packets during which the client received a retransmitted packet, are discarded as well. If there were no missing packets in the burst of packets and no retransmission in the middle of the burst, a bandwidth sample Bᵢ is measures in step 230 as follows.

Upon receiving the burst packets originated from the server system 12, the client system 14 measures the corresponding bandwidth based on the packet-pair concept and maintains a data base of collected samples in set B_{M}(t, Δ), wherein t represents the current time and A represents the “lifetime” of samples. That is, the client system 14 computes samples of the bottleneck bandwidth using the inter-packet spacing between the first and the last packets within each burst. Referring to FIG. 5, if the i-th burst consists of nᵢ packets and the k-th packet of the burst is received at time tᵢ(k), which contains sᵢ(k) bytes, the client system 14 computes partial bandwidth samples bᵢ(k) for each burst according to the following equation:

$${b}_{i} ( k ) = \frac{1}{δ ( k )} {\sum }_{j = 2}^{k} {s}_{i} ( j ) , where 2 \leq k \leq {n}_{i} and δ ( k ) = {t}_{i} ( k ) - {t}_{i} ( 1 ) ,$$

where each sample bᵢ(k) represents an estimate of the bandwidth using the first k (k≧2) packets of burst i. Here, the sum starts with the second packet (j=2) in computing the bandwidth as the burst duration [tᵢ(k)−tᵢ(1)] does not include the transmission time of the very first packet of the burst over the bottleneck link. Preferably, the number of packets nᵢ is set at least 3 packets in each burst; however, this number is not required. In the ERBPP method, each sample of bandwidth Bᵢ based on burst i is equal to the last partial sample: Bᵢ=bᵢ(nᵢ). In the multi-channel link environment (hereinafter referred to as ERBPP+method), sample Bᵢ is selected as the smallest value of partial samples bᵢ(k), for all k: Bᵢ=∀k: min (bᵢ(k)). Furthermore, the ERBPP method that considers only bursts with at least m packets is called ERBPPₘ. Suggested value of m is at least 3. Similarly, the ERBPP₊ method that analyzes at least m packets is called ERBPPₘ₊. The same value m=3 is suggested for ERBPPₘ₊. Once a samples Bᵢ is computed using ERBPPₘ or ERBPPₘ₊ at time t, it is added to the set of collected samples B_{M}(t, Δ) and stays there for no longer than Δ time units.

Accordingly, the client system 14 only needs to distinguish between packets in different bursts rather than the exact transmission time of each packet as required in the prior art. Hence, the only fields required in each packet header are one-bit (0 or 1) burst identifier and a packet sequence number. In addition, the inventive method has no bandwidth overhead associated with sending separate packet pairs as in the prior art since the actual video data in the form of a packet burst is used to compute the bandwidth. It is noted that the number of packets in a packet burst may be more than two packets depending on the streaming rate and desired burstiness. In addition, as many streaming media packet sizes are not constant, the number of packets per impulse (i.e., packet burst) varies.

Next, step 240 is performed at the discretion of the operator. This filtering step can be selectively performed by the client system 14 to improve the accuracy of the generated samples B_{M}(t, Δ) prior to selecting the new estimate of the bottleneck bandwidth. For simplicity, the new resulting bandwidth samples after undergoing the filtering process will be referred to as B_{I}(t, Δ) hereinafter. According to the exemplary embodiment of the present invention, there are two types of filtering approaches used to improve the accuracy of the bottleneck bandwidth estimation. The former approach filters the generated samples B_{M}(t, Δ) by maintaining the lifetime of samples A to a predetermined time period. Thus, any bandwidth samples generated that exceed a threshold sample lifetime would be eliminated from the B_{M}(t, Δ) in step 242. In the preferred embodiment, the recommended values Δ range between 30 and 300 seconds.

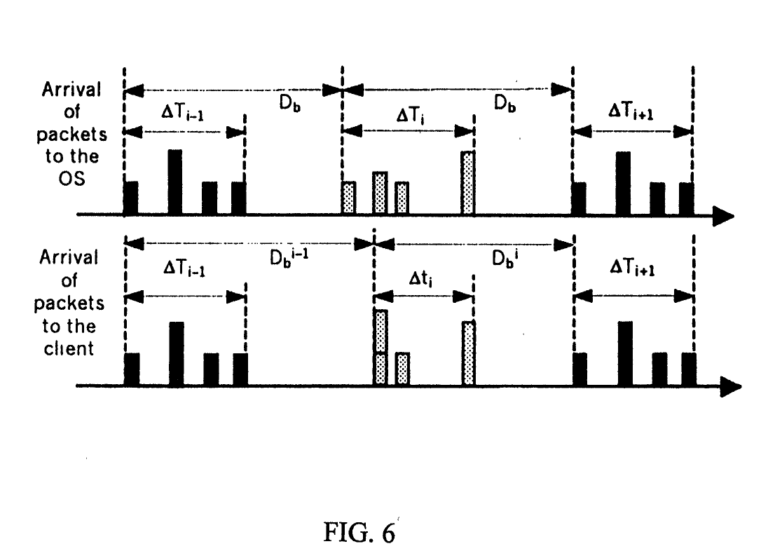

On the other hand, the latter approach relates to reducing the amount of error introduced by random and deterministic delays inside the OS kernel of the client system 14 in delivering packets to the application layer (i.e., process scheduling delays, delays caused by low-resolution clock in the data-link layer). FIG. 6 illustrates this type of undesirable delays, namely packet compression and packet expansion, which alter the spacing between packets. Here, the packet compression refers to packets in a burst that arrive to the client system 14 with the spacing smaller than the inter-packet delay introduced by the bottleneck link. This type of compression can occur, for example, if the first packet in a pair encounters a large queuing delay at some high-speed interface after going through the bottleneck router, and the second packet catches up with the first packet by encountering no or little queuing delay at the same interface. As shown in FIG. 6, the first packet of burst i (the burst in the middle) is delayed by the OS of the client system 14 until the second packet of the same burst is received by the kernel. Then, both packets are scheduled and delivered to the application layer. In such a case, the application can erroneously identify the beginning of burst i and use smaller burst length Δtᵢ (instead of ΔTᵢ) in its computation of ERBPPₘ bandwidth. The packet expansion refers to packets arriving to the client system 14 with the spacing larger than the one ideally introduced by the bottleneck link. The expansion can occur before or after passing the bottleneck router. As a consequence, the client system 14 can erroneously measure the bandwidth based on the expanded packet pair rather than the rate of the bottleneck link.

In order to eliminate an inaccurate estimation that may be caused by either the compression or expansion events, the exemplary embodiment of the present invention provides a filtering process to eliminate inaccurate bandwidth estimations out of the collected samples B_{M}(t, Δ) that is caused by the compression and/or expansion in step 244. The principle of the filtering operation is based on comparing the values of observed burst durations, D_{b}ⁱ and D_{b}ⁱ⁻¹ with the ideal value D_{b} for each received burst i. That is, the inaccurate bandwidth samples encountering the OS-related delay are determined based on the quantity difference between an ideal burst duration prior to encountering the OS delay and an actual burst duration after encountering the OS delay. Referring to FIG. 6, the length of each burst has a fixed duration of D_{b} time units (i.e., one burst is generated every D_{b} time units). If no significant compression occurs during the transmission, the respective burst lengths between the top and bottom graphs of FIG. 6 will agree. Thus, in cases when they do not agree or if the burst duration D_{b}ⁱ (the actual burst duration) deviates from D_{b} (the ideal burst duration) for more than α percent, the compression/expansion event is inferred. To state otherwise, if both |1−D_{b}ⁱ/D_{b}|≦α and |1−D_{b}ⁱ⁻1/D|≦α, then the corresponding bandwidth sample will be kept in set B_{M}(t, Δ) and will be eliminated otherwise in step 244. A suggested value of α, for example, ranges between 5% and 40%. For simplicity, the ERBPPₘ method with α-percent filtering is referred to as ERBPP_{m-α} hereinafter.

Finally, in step 260, the client system 14 according to the present invention determines a new real-time bandwidth from the set of filtered samples B_{I}(t, Δ) (note that if the filtering step 240 is not performed, set B_{I}(t, Δ) is equal to set B_{M}(t, Δ)) by determining a single estimate b_{EST}(t) representing the current value of the bottleneck link at time t. Here, the estimation of b_{EST}(t) is divided into two approaches, the median approach or the statistical approach of set B_{I}(t, Δ). The median mode is applied to low-speed links (below 128 Kbps) in step 264, while the statistical mode is applied to high-speed links (above 128 Kbps) in step 262. The statistical mode of a set is such value x where the probability distribution function (PDF)j(x) of the set reaches its maximum. In practice, the PDF is not known for finite sets and is usually replaced by the histogram of the set. The histogram of a set is computed by partitioning the set of values contained in the set into equal-size bins and computing the percentage of samples from the set that fall into each bin. The middle of the bin with the highest percentage is then selected as the mode of the set. For this invention, the suggested values for the bin size are between 1 Kbps and 5 Kbps. Accordingly, estimates b_{EST}(t) can be used for congestion control or other purposes at any required time t through the use of the median or mode of set B_{I}(t,Δ). Furthermore, if a multi-channel link is deployed (or believed to be deployed by the client) between the server system 12 and the client system 14, the client will use the ERBPPₘ₊ method rather than the ERBPPₘ method (note that if the filtering step 240 is not performed, set B_{I}(t, Δ) is equal to set B_{M}(t, Δ)).

In summary, the present invention provides a new bandwidth estimation mechanism, which achieves significant performance improvements over the existing bandwidth estimation algorithms. Having thus described a preferred embodiment for estimating the bottleneck bandwidth over a digital communications link, it should be apparent to those skilled in the art that certain advantages of the system have been achieved. The foregoing is to be constructed as only being an illustrative embodiment of this invention. Thus, persons skilled in the art can easily conceive of alternative arrangements providing a function similar to this embodiment without any deviation from the fundamental principles or the scope of this invention.

What is claimed is:

1. A method for estimating a bottleneck bandwidth used to support estimation of the bottleneck bandwidth between a server and a client in a communication system, the method comprising the steps of:
(a) transmitting a plurality of bursts comprised of packets from said server to said client via a bottleneck link of said system;
(b) computing a set of bandwidth samples from each of said bursts received by said client; and,
(c) determining a best bottleneck bandwidth from said computed bandwidth samples, for the following transmission of data packets from said server to said client.

2. The method of claim 1, further comprising the step of filtering for inaccurate bandwidth samples from said computed bandwidth samples by rejecting bandwidth samples having a sample life time greater than a threshold bandwidth lifetime.

3. The method of claim 1, further comprising the step of filtering for inaccurate bandwidth samples from said computed bandwidth samples by rejecting bandwidth samples encountering an operating system (OS) delay of said client system.

4. The method of claim 3, wherein the bandwidth samples encountering said OS delay is determined based on a quantity difference between an ideal burst duration prior to encountering said OS delay and an actual burst duration after encountering said OS delay.

5. The method of claim 1, further comprising the step of filtering for inaccurate bandwidth samples from said computed bandwidth samples by rejecting bandwidth samples having a retransmitted packet.

6. The method of claim 1, wherein the plurality of said packet bursts is transmitted at a maximum speed by said server system so that the inter-packet delay is introduced in each of said bursts.

7. The method of claim 1, wherein said new bandwidth corresponds to a median value of said computed bandwidth samples for a low speed link.

8. The method of claim 1, wherein said new bandwidth corresponds to the statistical mode of said computed bandwidth samples for a high speed link.

9. The method of claim 1, where in said new bandwidth corresponds to a minimum bandwidth of said computed bandwidth samples if a multi-channel link is deployed between said server and said client.

10. The method of claim 1, further comprising the step of eliminating bandwidth samples having a missing packet within each of said bursts.

11. The method of claim 1, wherein said bandwidth samples for each of said burst is computed based on a difference between an inter-packet spacing between the first and the last packet within each of said burst.

12. A method for estimating a bottleneck bandwidth used to support congestion control between a server and a client, the method comprising the steps of:
(a) transmitting by said server through a bottleneck link a plurality of burst comprised of packets to said client at a maximum rate;
(b) computing by said client a set of bandwidth samples for each of said burst packet, said bottleneck bandwidth being a difference between an inter-packet spacing between the first and the last packet within each of said bursts;
(c) filtering said computed bandwidth samples according to predetermined criteria; and,
(d) determining a new bottleneck bandwidth for the following transmission of data packets between said server and said client,
wherein determination of said new bottleneck bandwidth is based on said computed bandwidth samples and said and said filtering step.

13. The method of claim 12, wherein the step of computing said bandwidth samples comprises the steps of:
determining the start time and the end time of the reception of the first and the last packet within each of said bursts;
determining the packet size of the second packet and the last packet for each of said bursts; and,
computing said bandwidth samples based on a difference between the packet size of the second packet and the last packet, divided by a difference between an inter-packet spacing duration between the first and the last packet within each of said bursts.

14. The method of claim 12, wherein the plurality of said packet bursts is transmitted at a maximum rate by said server system so that the inter-packet delay is introduced in each of said bursts.

15. The method of claim 12, wherein the step of filtering said computed bandwidth samples comprises the step of rejecting bandwidth samples having a sample life time greater than a threshold bandwidth lifetime.

16. The method of claim 12, wherein the step of filtering said computed bandwidth samples comprises the step of rejecting bandwidth samples encountering an operating system (OS) delay of said client system.

17. The method of claim 16, wherein the bandwidth samples encountering said OS delay is determined based on a quantity difference between an ideal burst duration prior to encountering said OS delay and an actual burst duration after encountering said OS delay.

18. The method of claim 12, wherein the step of filtering said computed bandwidth samples comprises the step of rejecting bandwidth samples having a retransmitted packet.

19. The method of claim 12, wherein said new bandwidth corresponds to a median value of said computed bandwidth samples for a low speed link.

20. The method of claim 12, wherein said new bandwidth corresponds to the statistical mode of said computed bandwidth samples for a high speed link.

21. The method of claim 12, where in said new bandwidth corresponds to a minimum bandwidth of said computed bandwidth samples if a multi-channel link is deployed between said server and said client.

22. The method of claim 12, further comprising the step of eliminating bandwidth samples having a missing packet within each of said bursts.

23. A device for estimating a bottleneck bandwidth used to support congestion control between a server and a client, the method comprising the steps of:
means for transmitting plurality of bursts comprised of packets;
means for receiving said burst packets via a bottleneck link;
means for generating a set of bandwidth samples based on a difference between an inter-packet spacing between the first and the last packet within each of said bursts; and,
means for determining a new bottleneck bandwidth from said generated bandwidth samples for the following transmission of data packets between said server and said client.

24. The device of claim 23, further comprising a means for filtering said generated bandwidth samples by eliminating one of said generated bandwidth samples exceeding a threshold bandwidth lifetime.

25. The device of claim 23, further comprising a means for filtering said generated bandwidth samples by eliminating one of said generated bandwidth samples encountering an operating system (OS) delay of said client.

26. The device of claim 23, further comprising a means for filtering said generated bandwidth samples by eliminating one of said generated bandwidth samples having a retransmitted packet.
